(19) United States
(12) Patent Application Publication
(10) Pub. No.: US 2026/0196549 A1
(43) Pub. Date: Jul. 9, 2026

(54) FOLDING APPARATUS FOR BATTERY CELL

(71) Applicant: SK On Co., Ltd., Seoul (KR)

(72) Inventor: Seung Hyeon CHEON, Daejeon (KR)

(21) Appl. No.: 19/439,486

(22) Filed: Jan. 5, 2026

(30) Foreign Application Priority Data
Jan. 6, 2025 (KR) 10-2025-0001642

(51) Int. Cl. H01M 10/04

(52) U.S. Cl. CPC H01M 10/0404; H01M 10/0481

(57) ABSTRACT

A folding apparatus for a battery cell includes a stripper gripping a terrace of a cell case having an electrode receiving portion, the stripper being configured to restrain movement of the terrace, a first bending member contacting a first surface of the terrace to press the terrace, and performing a first bending of the terrace, a second bending member contacting a second surface of the terrace to press the terrace, and performing a second bending of the terrace, and a tape attachment portion securing the terrace by attaching tape to the terrace while the terrace is folded.

### CROSS-REFERENCE TO RELATED APPLICATION(S

This patent document claims the priority and benefits of Korean Patent Application No. 10-2025-0001642 filed on January 6, 2025, the disclosure of which is incorporated herein by reference in its entirety.

### TECHNICAL FIELD

The disclosure relates to a folding apparatus for a battery cell in which a terrace of a pouch-type battery cell is folded.

### BACKGROUND

Secondary battery cells, unlike primary batteries, offer the convenience of being rechargeable, and are attracting significant attention as a power source for various mobile devices, electric vehicles, and energy storage devices.

Secondary battery cells may be manufactured as pouch-type or can-type cells. Pouch-type cells have a structure in which the electrode assembly is housed within a flexible cell case (pouch). Can-type cells have a structure in which the electrode assembly is housed within a rigid cell case (can) and may be configured as cylindrical, prismatic, coin-shaped cells, or the like.

The pouch-type cell case includes an electrode receiving portion that houses the electrode assembly and a terrace that is disposed on at least a portion of the periphery of the electrode receiving portion and has a shape extending outwardly from the electrode receiving portion. At least a portion of the terrace may be thermally welded (compressed) to form a sealing portion. The sealing portion seals the electrode receiving portion from the outside.

### SUMMARY

To prevent external moisture from penetrating into the battery cell, the sealing portion formed on the terrace is required to have a predetermined minimum width. Increasing the width of the sealing portion may increase the volume of the battery cell. To improve the bonding reliability of the sealed sealing portion and reduce the volume occupied by the terrace, the terrace may be folded to form a folding portion in the terrace. Jigs and/or rollers may be used for folding the terrace.

The folding process may be performed sequentially, including a first folding process that folds the terrace at a first angle, followed by a second folding process that folds the terrace at a second angle, and the like.

Using rollers to fold the terrace may shorten the cycle time, as compared to using jigs. However, meandering may occur during the process of folding the terrace by a roller. To reduce meandering, a pre-folding line, which serves as a reference for folding, may be formed on the terrace before folding the terrace at a preset angle. Additionally, a heat pressing process or a sizing process may be performed to additionally pressurize the folding portion to prevent the folding portion from unfolding due to springback.

The present disclosure can be implemented in some embodiments to provide a folding apparatus for a battery cell in which the forming process of the folding portion is simplified and productivity is improved.

According to an aspect of the present disclosure, a folding apparatus for a battery cell facilitating the formation of the folding portion may be provided.

According to an aspect of the present disclosure, a folding apparatus for a battery cell in which the equipment for folding processing may be simplified and equipment costs may be reduced may be provided.

Battery cells manufactured using the folding apparatus for a battery cell in the present disclosure may be widely applied in green technology fields such as electric vehicles, battery charging stations, and other battery-based solar and wind power generation. In addition, the battery cell manufactured by the folding apparatus according to an aspect of the present disclosure may be used in eco-friendly electric vehicles, hybrid vehicles, and the like to ameliorate the effects of climate change by suppressing air pollution and greenhouse gas emissions.

In some embodiments of the present disclosure, a folding apparatus for a battery cell includes a stripper gripping a terrace of a cell case having an electrode receiving portion, the stripper being configured to restrain movement of the terrace; a first bending member contacting a first surface of the terrace to press the terrace, and performing a first bending of the terrace; a second bending member contacting a second surface of the terrace to press the terrace, and performing a second bending of the terrace; and a tape attachment portion securing the terrace by attaching tape to the terrace while the terrace is folded.

In an embodiment, the stripper may include a first stripper and a second stripper, disposed facing each other, with the terrace interposed therebetween, and the first stripper and the second stripper may move in a thickness direction of the electrode receiving portion, press the terrace, and suppress the movement of the terrace.

In an embodiment, the first bending member and the second bending member may move in the thickness direction of the electrode receiving portion to bend the terrace.

In an embodiment, the first bending member and the second bending member may move in opposite directions to bend the terrace.

In an embodiment, a folding portion formed by bending the terrace may include a first portion restrained from movement by the stripper, a second portion extending from the first portion and disposed between the first bending member and the stripper, and a third portion extending from the second portion and disposed between the first bending member and the second bending member.

In an embodiment, the second bending member may bend the terrace such that the second portion and the third portion are disposed parallel to each other.

In an embodiment, the folding apparatus for a battery cell may further include a pressing portion pressing the terrace and maintaining a folded shape of the terrace, after the first and second bending members are returned to original positions thereof.

In an embodiment, the pressing portion may contact the third portion and press the third portion toward the electrode receiving portion.

In an embodiment, the tape attachment portion may include an adsorption portion absorbing the tape and attaching a central portion of the tape to the terrace; and a pressing roller portion attaching both side portions of the tape to the electrode receiving portion.

In an embodiment, the pressing roller portion may include a pair of rollers disposed on a rear side of the tape, on both sides of the adsorption portion, and the pair of rollers may be arranged to be movable to a position facing the electrode receiving portion while pressing the tape.

In an embodiment, the pressing portion may be provided as a plurality of pressing portions spaced apart from each other, and the tape attachment portion may be positioned between the plurality of pressing portions to attach the tape.

In an embodiment, the first bending member may include a blade, and the second bending member includes a blade or a folding roller.

In some embodiments of the present disclosure, a folding apparatus for a battery cell includes a stripper gripping a terrace of a cell case having an electrode receiving portion, the stripper being configured to movement of the terrace; a bending member bending the terrace and forming a folding portion; a pressing portion pressing the folding portion and to suppress springback of the folding portion; and a tape attachment portion attaching tape to the folding portion pressed by the pressing portion to secure the folding portion.

In an embodiment, the pressing portion may be provided as a plurality of pressing portions spaced apart from each other, and the tape attachment portion may be disposed between the plurality of pressing portions.

In an embodiment, the bending member may bend the terrace while moving in a thickness direction of the electrode receiving portion.

### BRIEF DESCRIPTION OF DRAWINGS

Certain aspects, features, and advantages of the present disclosure are illustrated by the following detailed description with reference to the accompanying drawings.

FIG. 1 is a plan view of a folding processing cell according to an embodiment.

FIG. 2 is a cross-sectional view taken along line I-I’ of FIG. 1.

FIG. 3 is a perspective view of a battery cell according to an embodiment.

FIG. 4 is a cross-sectional view taken along line II-II’ of FIG. 3.

FIG. 5 is a schematic diagram illustrating a folding apparatus for a battery cell according to an embodiment.

FIGS. 6 to 12 are sequential diagrams illustrating a process of folding a terrace using the folding apparatus for a battery cell illustrated in FIG. 5.

FIG. 13 is a side view schematically illustrating the disposing structure of a pressing portion and a tape attachment device illustrated in FIG. 5.

FIGS. 14 and 15 are schematic diagrams illustrating a folding apparatus for a battery cell according to another embodiment.

### DETAILED DESCRIPTION

Features of the present disclosure disclosed in this patent document are described by example embodiments with reference to the accompanying drawings.

Hereinafter, the present disclosure will be described in detail with reference to the attached drawings. However, these are merely illustrative and the present disclosure is not limited to the detailed embodiments described herein.

In describing the present disclosure, the inner and outer directions may be defined with respect to the electrode assembly. For example, the inner direction may refer to a direction toward or closer to the electrode assembly, and the outer direction may refer to a direction opposite to the inner direction, a direction away from the electrode assembly.

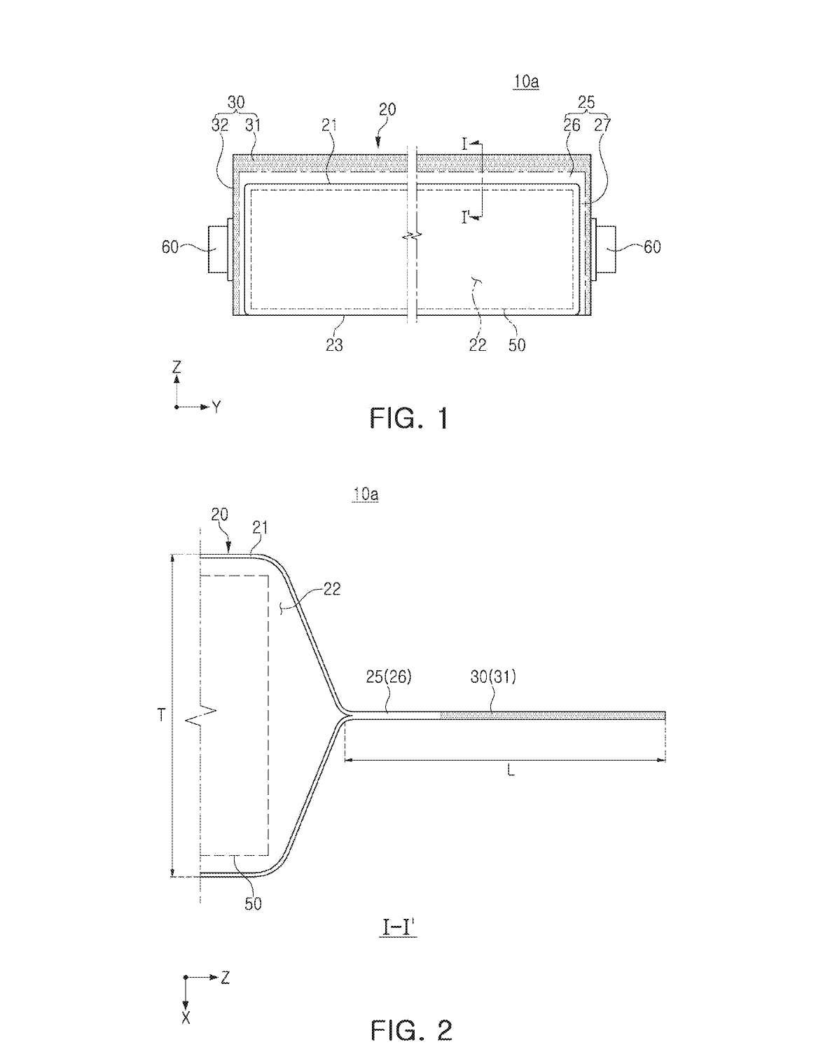

FIG. 1 is a plan view of a folding processing cell according to an embodiment, and FIG. 2 is a cross-sectional view taken along line I-I’ of FIG. 1.

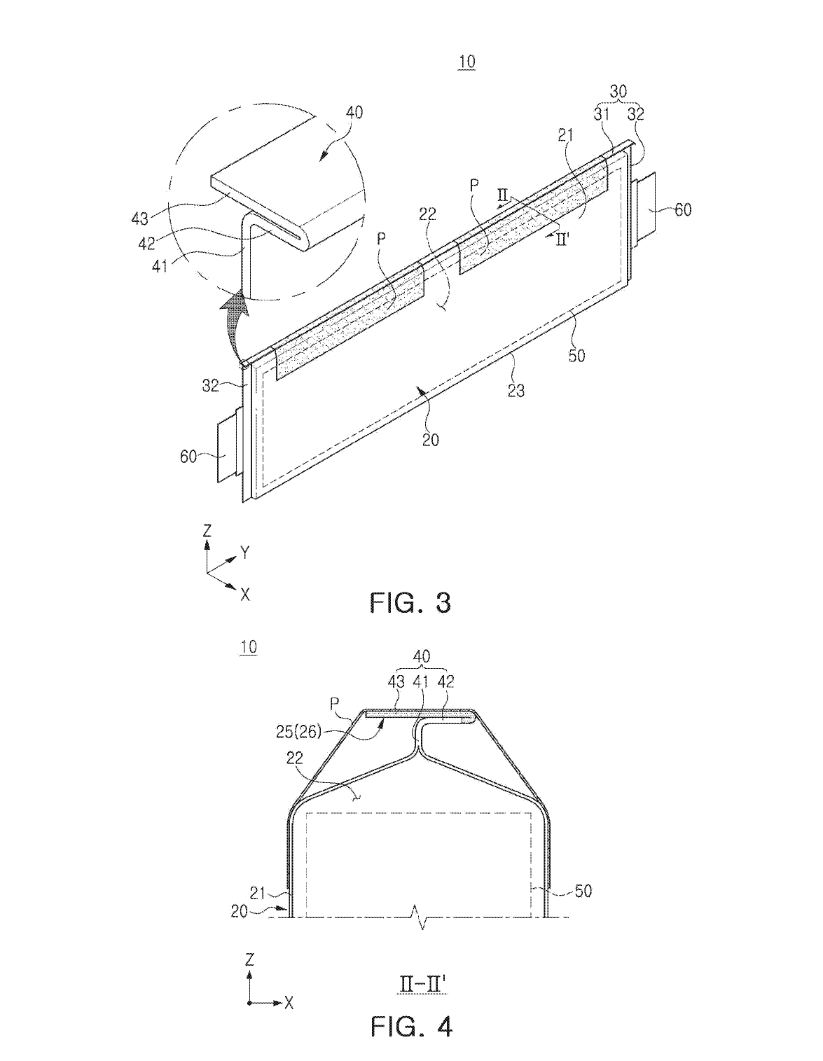

FIGS. 1 and 2 illustrate a folding processing cell 10a prior to folding processing. The battery cell 10 of FIG. 3 of the present disclosure may be formed by folding the terrace 25 of the folding processing cell 10a.

Referring to FIGS. 1 and 2, the folding processing cell 10a may include an electrode assembly 50, an electrode lead 60, and a cell case 20.

The electrode assembly 50 may include a plurality of cathodes, a plurality of anodes, and a plurality of separators. The separator may be disposed between the cathode and the anode. The plurality of cathodes, anodes, and separators may be arranged to form a plurality of layers.

The electrode lead 60 is electrically connected to the electrode assembly 50, and a portion thereof may be exposed to the outside of the cell case 20.

The cell case 20 may include an electrode receiving portion 21 that accommodates the electrode assembly 50, and a terrace 25 that is disposed at least partially around the periphery of the electrode receiving portion 21 and extends outward from the electrode receiving portion 21. The electrode receiving portion 21 may include a receiving space 22 that accommodates the electrode assembly 50 therein.

The terrace 25 may have a flange shape that extends outward from the electrode receiving portion 21. At least a portion of the terrace 25 may be thermally welded (compressed) to form a sealing portion 30. The sealing portion 30 may seal the receiving space 22. The width of the sealing portion 30 formed on the terrace 25 may be set within a range that prevents external moisture from penetrating into the battery cell 10.

The terrace 25 may include a first terrace 26 located on a surface where the electrode lead 60 is not disposed, and a second terrace 27 located on a surface where the electrode lead 60 is disposed.

The sealing portion 30 may include a first sealing portion 31 formed on the first terrace 26 where the electrode lead 60 is not disposed, and a second sealing portion 32 formed on the second terrace 27 where the electrode lead 60 is disposed. When forming the electrode receiving portion 21 by folding a single sheet of outer material (for example, a pouch film), three of the four sides of the electrode receiving portion 21 may be open, and one side 23 may be closed. A sealing portion 30 may be formed on the terrace 25 corresponding to the three open sides of the electrode receiving portion 21.

The cell case 20 may have a preset thickness T, and the terrace 25 may have a preset width L. The width L of the terrace 25, the thickness T of the cell case 20, the location of the area in the terrace 25 where the sealing portion 30 is formed, and/or the width of the sealing portion 30 may vary.

However, the battery cell 10 of FIG. 3 or the folding processing cell 10a of the present disclosure is not limited to a structure in which the sealing portion 30 is formed on three sides of the electrode receiving portion 21. For example, the folding processing cell 10a may also have a configuration in which the electrode receiving portion 21 is formed by overlapping two outer layers. In this case, the sealing portion 30 may be formed on all four sides corresponding to the thickness of the electrode receiving portion 21.

FIG. 3 is a perspective view of a battery cell according to an embodiment, and FIG. 4 is a cross-sectional view taken along line II-II’ of FIG. 3.

Referring to FIGS. 3 and 4 , a battery cell 10 according to an embodiment may have a shape in which a folding portion 40 is formed on the terrace 25 of the folding processing cell 10a illustrated in FIGS. 1 and 2 by folding the terrace 25.

The battery cell 10 may include an electrode assembly 50, an electrode lead 60, and a cell case 20. The descriptions of FIGS. 1 and 2 may also apply to the electrode assembly 50 and electrode lead 60 of FIGS. 3 and 4 .

The cell case 20 may include an electrode receiving portion 21 that accommodates an electrode assembly 50, and a terrace 25 that is disposed on at least a portion of the circumference of the electrode receiving portion 21 and extends outward from the electrode receiving portion 21. At least a portion of the terrace 25 may be thermally bonded (compressed) to form a sealing portion 30. The terrace 25 may include a first terrace 26 that is positioned on a surface where the electrode lead 60 is not disposed, and a second terrace 27 that is positioned on a surface where the electrode lead 60 is disposed. The sealing portion 30 may include a first sealing portion 31 formed on the first terrace 26 where the electrode lead 60 is not disposed, and a second sealing portion 32 formed on the second terrace 27 where the electrode lead 60 is disposed. The descriptions of FIGS. 1 and 2 may also be applied to the electrode receiving portion 21 and the sealing portion 30 of the terrace 25 of FIGS. 3 and 4.

At least a portion of the terrace 25 may be folded to form a folding portion 40. The folding portion 40 may be formed by folding the first terrace 26 without disposing the electrode lead 60. The folding portion 40 may be formed to increase the bonding reliability of the sealed sealing portion 30 and reduce the volume occupied by the terrace 25.

The folding portion 40 may include a first portion 41, a second portion 42, and a third portion 43. The first portion 41 may include a portion of the terrace 25 extending from the electrode receiving portion 21 in the first direction (Z-axis direction). In the present disclosure, the first direction is a direction parallel to the plane direction of the electrode assembly 50, and may be the direction in which the first terrace 26 extends from the electrode receiving portion 21.

In the present disclosure, the first direction may be defined as including both the +Z-axis and -Z-axis directions on the coordinate axis.

The first portion 41 of the first terrace 26 may refer to the unfolded portion of the first terrace 26 illustrated in FIG. 1.

The second portion 42 may be connected to the first portion 41 and may be disposed to form a first angle θ with the first portion 41. The second portion 42 may have a bent shape based on the boundary with the first portion 41. The first angle θ may be defined as the inner angle between the first portion 41 and the second portion 42. The second portion 42 may have a shape bent in a first rotational direction (for example, clockwise with respect to FIG. 4) based on the boundary between the first portion 41 and the second portion 42.

The first angle θ may have a value greater than or equal to 45 degrees and less than or equal to 105 degrees. For example, as illustrated in FIG. 4, the first angle θ may be 90 degrees, but is not limited thereto.

The third portion 43 may be connected to the second portion 42 and may be disposed to form a second angle with the second portion 42. The third portion 43 may have a shape bent based on the boundary with the second portion 42. The second angle may be defined as the inner angle between the second portion 42 and the third portion 43. The third portion 43 may have a shape bent in a second rotational direction (for example, counterclockwise as shown in FIG. 4) based on the boundary between the second portion 42 and the third portion 43.

The second angle may be 0 degrees. In this case, the second portion 42 and the third portion 43 may be disposed parallel to each other.

The second portion 42 may be positioned between the first portion 41 and the third portion 43, and the third portion 43 may be disposed on the outside of the second portion 42. For example, the third portion 43 may be positioned on the opposite side of the electrode receiving portion 21 relative to the second portion 42.

The rotational direction (for example, counterclockwise) in which the third portion 43 is bent may be opposite the rotational direction (for example, clockwise) in which the second portion 42 is bent.

In an embodiment, the width of the third portion 43 may be formed to be longer than the width of the second portion 42. In this case, the third portion 43 may face the first portion 41.

However, the present disclosure is not limited thereto, and the width of the third portion 43 may be formed to be less than or equal to the width of the second portion 42.

At least a portion of the second portion 42 and at least a portion of the third portion 43 may include a sealing portion 30.

The overall width of the first portion 41, the second portion 42, and the third portion 43 may be equal to the width (L in FIG. 2) of the terrace 25 before forming the folding portion 40.

A tape P may be attached to the folding portion 40. The tape P may be attached to restrain movement of the folding portion. The central portion of the tape P may be attached to the third portion 43, and both side portions may be attached to the electrode receiving portion 21.

As illustrated in FIG. 3, multiple tapes P may be spaced apart and attached to the battery cell 10.

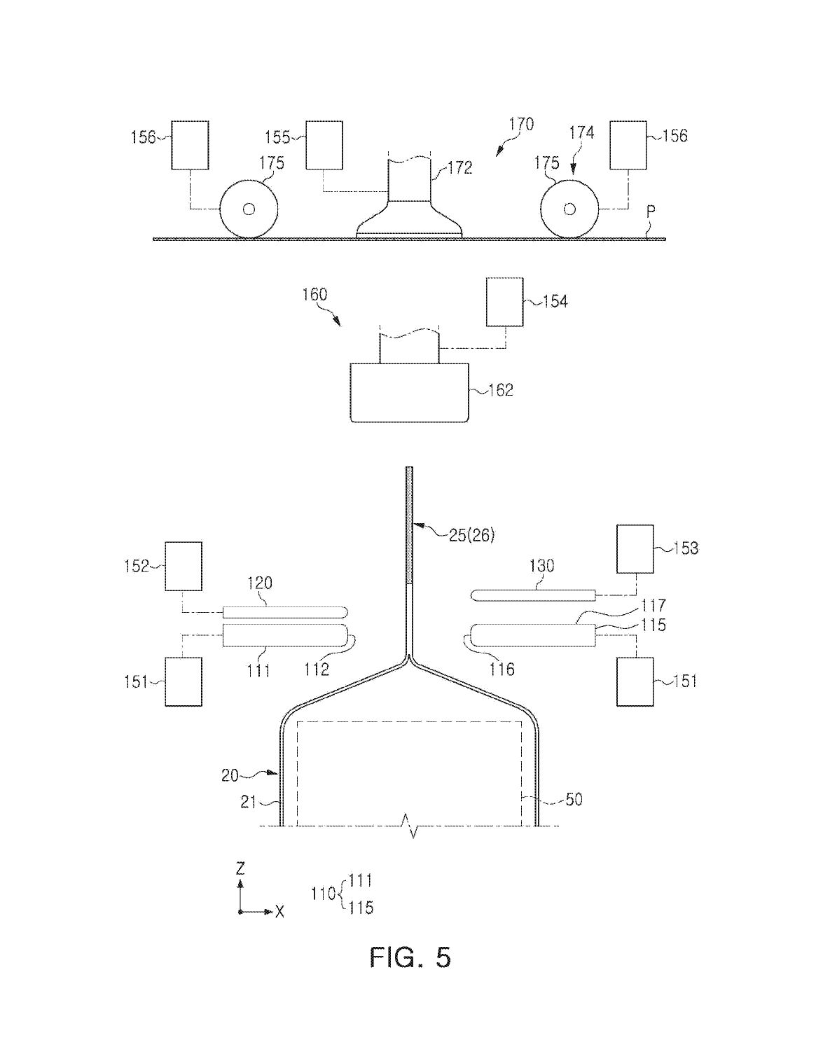

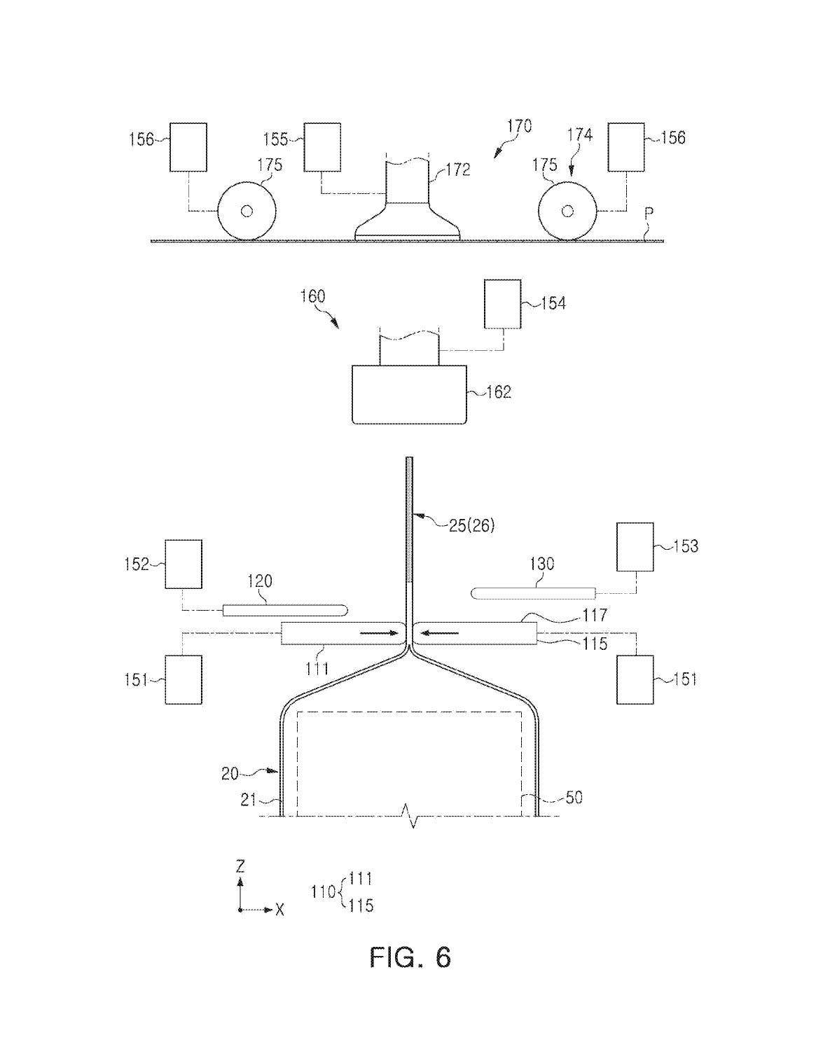

FIG. 5 is a schematic diagram illustrating a folding apparatus for a battery cell according to an embodiment. Additionally, FIGS. 6 through 12 sequentially illustrate the process of folding a terrace using the folding apparatus for a battery cell illustrated in FIG. 5.

Referring to FIGS. 5 through 12 together, the folding apparatus for a battery cell 100 of the present embodiment may fold the terrace 25 of the folding processing cell 10a illustrated in FIG. 1 to form a folding portion 40 on the terrace 25.

A folding apparatus for a battery cell 100 according to an embodiment may include a stripper gripping a terrace 25 of a cell case having an electrode receiving portion 21, the stripper being configured to restrain movement of the terrace 25, a first bending member 120 contacting a first surface of the terrace 25 to press the terrace 25 and perform a first bending of the terrace 25, a second bending member 130 contacting a second surface of the terrace 25 to press the terrace 25 and perform a second bending of the terrace 25, and a tape attachment portion 170 securing the terrace 25 by attaching tape P to the terrace 25 while the terrace 25 is folded.

Furthermore, a folding apparatus for a battery cell 100 according to an embodiment may include a stripper 110 gripping a terrace 25 of a cell case having an electrode receiving portion 21, the stripper being configured to restrain movement of the terrace 25, a bending member 120, 130 that bends the terrace 25 to form a folding portion 40, a pressing portion 160 that presses the folding portion 40 to suppress springback of the folding portion 40, and a tape attachment portion 170 that attaches tape P to the folding portion 40 pressed by the pressing portion 160 to secure the folding portion 40.

The stripper 110 may be formed in a block or plate shape and may support the terrace 25 of the cell case 20 from both sides. As illustrated in FIG. 6, the stripper 110 is disposed on a portion of the terrace 25 adjacent to the electrode receiving portion 21, pressurizing the terrace 25 and gripping the terrace 25.

The stripper 110 may include a first stripper 111 and a second stripper 115, which are disposed facing each other with the terrace 25 interposed therebetween. The first stripper 111 and the second stripper 115 move in the thickness direction of the electrode receiving portion 21 and pressurize the terrace 25, and suppress the movement of the terrace 25.

The first stripper 111 may include a first contact surface 112 that contacts one surface of the terrace 25, and the second stripper 115 may include a second contact surface 116 that contacts the other surface of the terrace 25. The first stripper 111 and the second stripper 115 may pressurize the terrace 25 with a preset pressure so that the terrace 25 does not move during folding processing.

In FIG. 5, the first contact surface 112 of the first stripper 111 and the second contact surface 116 of the second stripper 115 are illustrated as having the same width, but the widths of the first contact surface 112 and the second contact surface 116 may be varied. Each of the first stripper 111 and the second stripper 115 may include a first surface facing the electrode receiving portion 21 and a second surface opposite to the first surface. In this case, the second surface may function as a support surface 117 that supports the terrace 25 when the terrace 25 is folded. Therefore, the support surface 117 may be formed flat and may be formed parallel to the direction in which the first bending member 120 described below moves.

The first driving unit 151 may move the stripper 110 in a second direction (X-axis direction), which is the thickness direction of the electrode assembly 50. Therefore, the second direction may be a direction orthogonal to the first direction. Furthermore, in the present disclosure, the second direction may be defined as including both the +X-axis direction and the -X-axis direction on the coordinate axis.

The first driving unit 151 may move the first stripper 111 and the second stripper 115 along the second direction so that the first stripper 111 and the second stripper 115 approach or move away from the terrace 25. For example, the first driving unit 151 may drive the stripper 110 so that the first stripper 111 and the second stripper 115 simultaneously approach and pressurize the terrace 25.

The first bending member 120 and the second bending member 130 may move in the thickness direction of the electrode receiving portion 21 to bend the terrace. In an embodiment, the first bending member 120 and the second bending member 130 may move in opposite directions to bend the terrace 25.

The first bending member 120 and the second bending member 130 may be disposed on both sides of the terrace 25, respectively, and may be disposed to allow reciprocal movement toward the terrace 25. For example, with respect to the terrace 25, the first bending member 120 may be disposed on the first surface side of the terrace 25 where the first stripper 111 is disposed, and the second bending member 130 may be disposed on the second surface side of the terrace 25 where the second stripper 115 is disposed.

As described above, the folding portion 40 may be formed on the first terrace 26 where the electrode lead 60 is not disposed. Therefore, the first bending member 120 and the second bending member 130 may be disposed to face the first terrace 26. In the following description, “terrace 25” refers to the first terrace 26 unless otherwise specified.

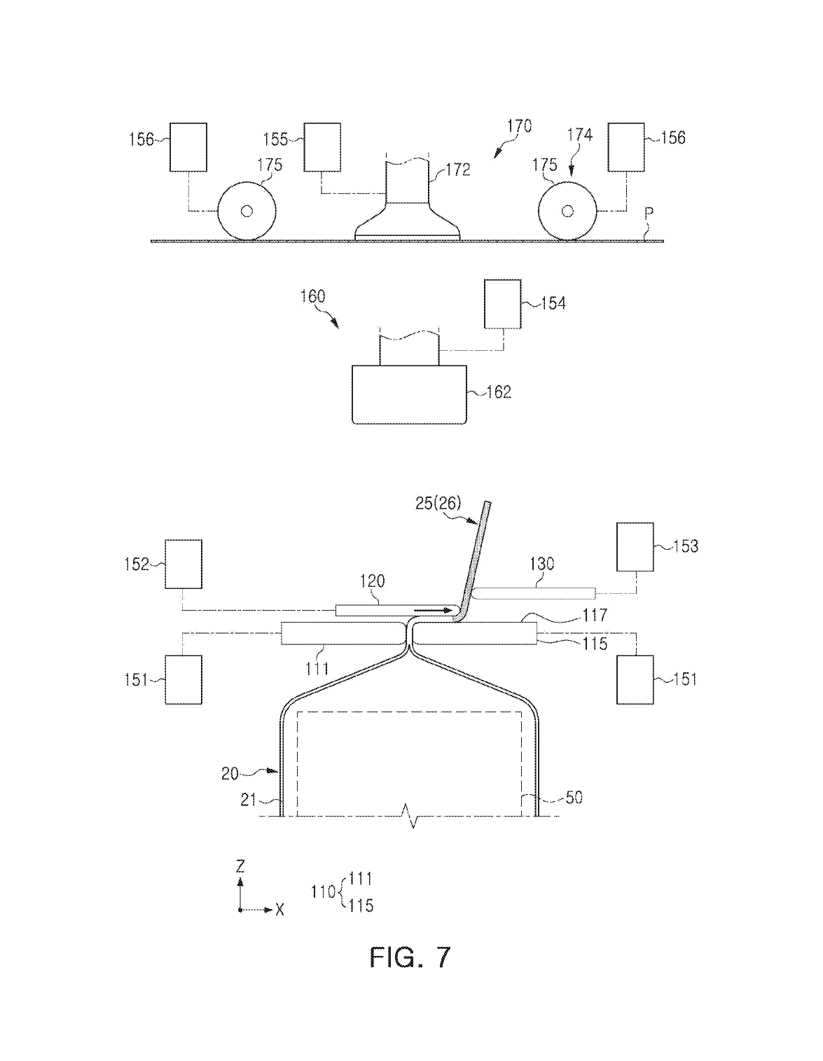

The first bending member 120 may be formed in the form of a flat plate and may be disposed to face the first surface of the terrace 25. The first bending member 120 may be disposed so that the surface direction thereof is perpendicular to the first surface of the terrace 25. As illustrated in FIG. 7, the terrace 25 may be folded initially by moving along the second direction (+X-axis direction). Accordingly, the terrace 25 may be folded with an end thereof rotating in the +X-axis direction.

The first bending member 120 may be disposed parallel to the stripper 110 and facing the support surface 117 of the stripper 110. A folded terrace 25 may be disposed between the first bending member 120 and the stripper 110. Therefore, the gap between the first bending member 120 and the stripper 110 may be formed according to the thickness of the terrace 25.

To prevent damage to the terrace 25 when the first bending member 120 contacts the terrace 25, the corner where the first bending member 120 contacts the terrace 25 may be formed as a curved surface.

The first bending member 120 may divide the folding portion 40 into a first portion 41 and a second portion 42.

During the first folding process by the first bending member 120, the first bending member 120 may fold the terrace 25 at a 90° angle. However, this is not a limitation, and the angle at which the terrace 25 is folded may vary depending on the movement direction of the stripper’s support surface 117 and the first bending member 120.

The second driving unit 152 may reciprocate the first bending member 120. The second driving unit 152 may drive the first bending member 120 so that the first bending member 120 reciprocates in the second direction. However, the movement direction of the first bending member 120 is not limited thereto, and the first bending member 120 may also move in a direction inclined with respect to the second direction. In this case, the stripper’s support surface 117 may be formed parallel to the movement direction of the first bending member 120.

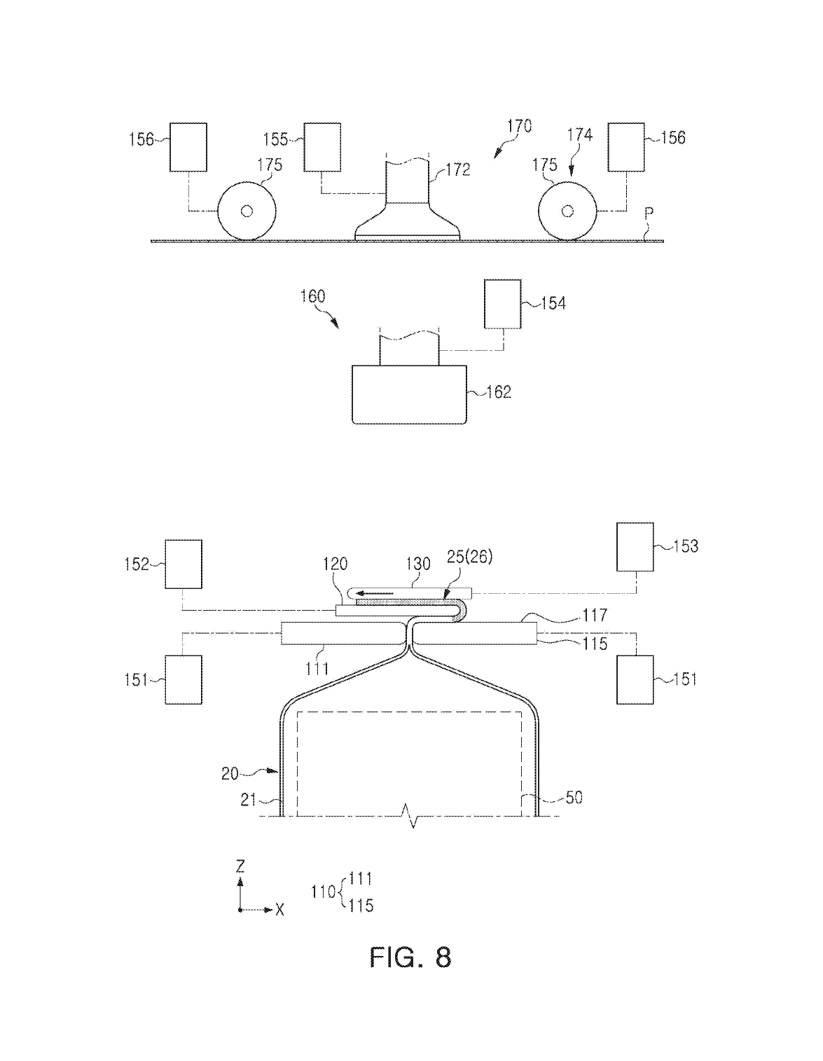

The second bending member 130 may be formed in the form of a flat plate and disposed to face the second surface of the terrace 25. The second bending member 130 may be disposed so that the surface direction thereof is perpendicular to the second surface of the terrace 25. As illustrated in FIG. 8, the second bending member 130 may move along the second direction (the -X-axis direction) and perform a secondary folding of the terrace 25. Accordingly, the terrace 25 may be folded while an end thereof rotates in the -X-axis direction.

With respect to the first direction (the Z-axis direction), the second bending member 130 may be disposed outside the first bending member 120, and the first bending member 120 may be positioned between the second bending member 130 and the stripper 110.

The second bending member 130 may be disposed parallel to the stripper 110 and the first bending member 120, and may be disposed to face the support surface 117 of the stripper 110. A folded terrace 25 may be disposed between the first bending member 120 and the second bending member 130. Accordingly, the gap between the first bending member 120 and the second bending member 130 may be formed to correspond to the thickness of the terrace 25.

To prevent damage to the terrace 25 when the second bending member 130 contacts the terrace 25, the corner where the second bending member 130 contacts the terrace 25 may be formed as a curved surface.

During the secondary folding process, the second bending member 130 may fold the terrace 25 such that the terrace 25 wraps around the first bending member 120, thereby allowing the terrace 25 to fold 180°. However, the present disclosure is not limited thereto, and the angle at which the terrace 25 folds during the secondary folding process may vary depending on the angles or movement directions of the second bending member 130 and the first bending member 120.

The folding portion 40 may be divided into a second portion 42 and a third portion 43 by the second bending member 130. For example, the folding portion 40 formed by folding the terrace 25 may include a first portion 41 restrained from movement by the stripper 110, a second portion 42 extending from the first portion 41 and disposed between the first bending member 120 and the stripper, and a third portion 43 extending from the second portion 42 and disposed between the first bending member 120 and the second bending member 130.

The second bending member 130 may bend the terrace 25 so that the second portion 42 and the third portion 43 are disposed in parallel to each other. Therefore, after the second folding process, the second portion 42 and the third portion 43 may be disposed so that at least portions thereof face each other, with the first bending member 120 interposed therebetween.

The third driving unit 153 may reciprocate the second bending member 130. The third driving unit 153 may drive the second bending member 130 so that it reciprocates in the second direction (X-axis direction). However, the movement direction of the second bending member 130 is not limited to this, and the second bending member 130 may also move in a direction inclined with respect to the second direction, which is the thickness direction of the cell case 20.

Once the terrace 25 is divided into a first portion 41, a second portion 42, and a third portion 43 through the first and second folding processes, forming the folding portion 40, the first bending member 120 and the second bending member 130 may be returned to the original positions thereof.

In an embodiment, the first bending member 120 may include a blade. Furthermore, the second bending member 130 may include a blade or, as described below, a folding roller 132. In this case, the blade may be formed with a thickness that decreases toward the end.

The pressing portion 160 may apply pressure to the terrace 25 after the first bending member 120 and the second bending member 130 are returned to the original positions thereof, thereby maintaining the folded shape of the terrace 25.

The pressing portion 160 may prevent the folded portion of the folding portion 40 from unfolding due to the springback phenomenon. To this end, the pressing portion 160 may contact the third portion 43 to apply pressure to the folding portion 40. For this purpose, the pressing portion 160 may include a pressing block 162 and a fourth driving unit 154.

The pressing block 162 may be disposed at a predetermined distance from the battery cell 10 in the first direction and may be disposed to be movable in the first direction by the fourth driving unit 154.

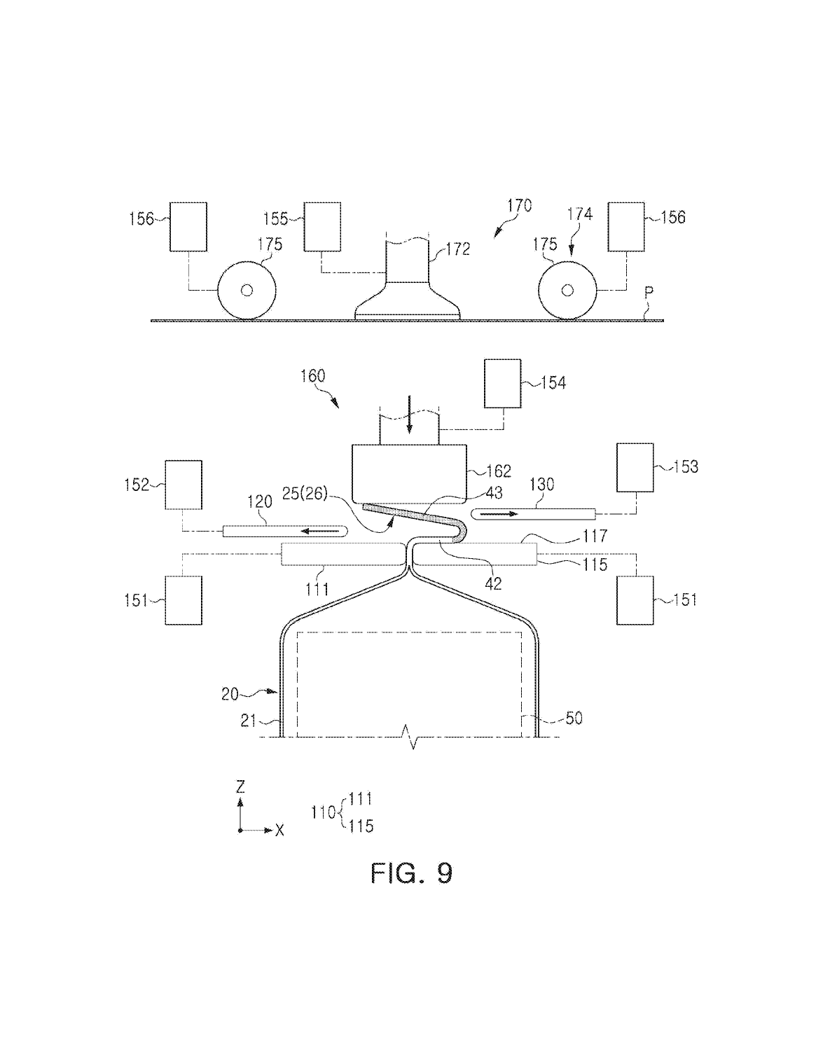

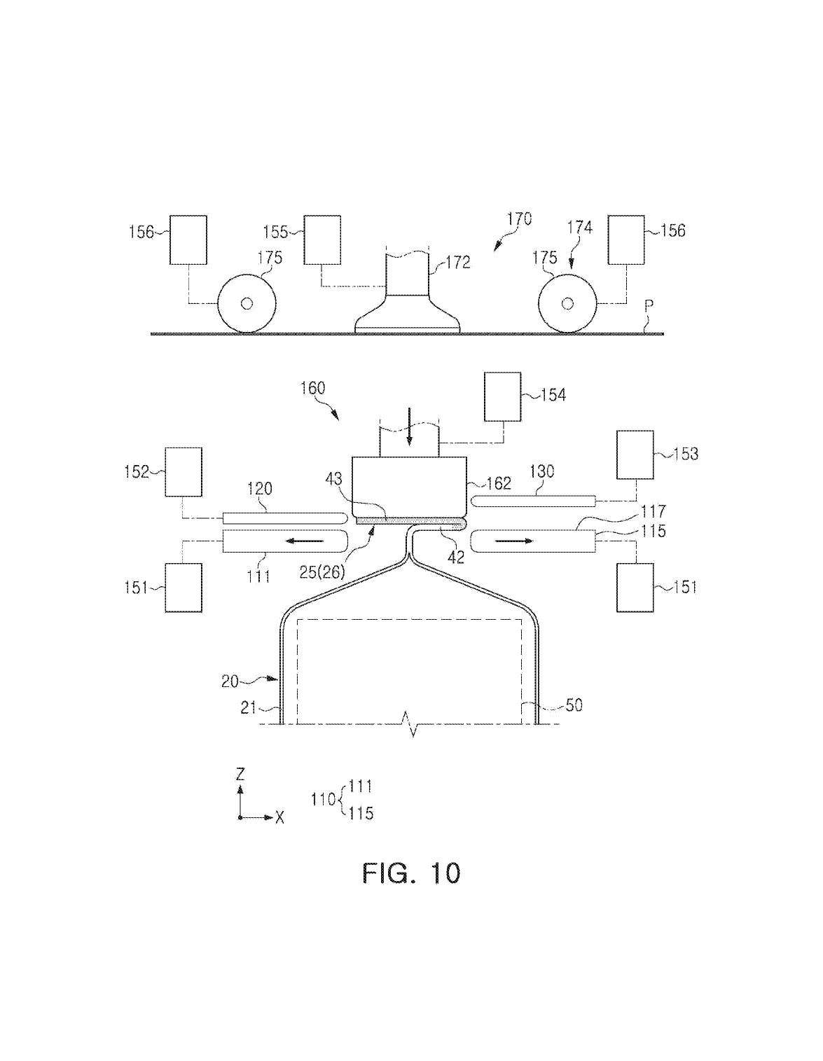

The pressing block 162 may contact the third portion 43 while the first bending member 120 and the second bending member 130 are in the original positions thereof, and then move a predetermined distance toward the stripper in the first direction. As illustrated in FIGS. 9 and 10, the pressing block 162 may contact the third portion 43 and press the third portion 43 toward the electrode receiving portion 21.

Therefore, the third portion 43, which has been partially unfolded due to the springback phenomenon, may again approach the second portion 42, and the folding portion 40 may be maintained in a folded state similar to that illustrated in FIG. 9. In an embodiment, the third portion 43 may be in close contact with the second portion 42 or maintained in a state parallel to the second portion 42.

The fourth driving unit 154 may reciprocate the pressing block 162. The fourth driving unit 154 may drive the pressing block 162 so that it moves in the first direction. However, the direction of movement of the pressing block 162 is not limited to this and may be modified in various ways as long as the third portion 43 may be pressed to maintain the folded state.

Multiple pressing portions 160 of the present embodiment may be disposed spaced apart from each other. In this embodiment, the pressing portion 160 may be provided to prevent the folded portion from unfolding again due to springback during the process of attaching tape P to the folding portion 40 by the tape attachment portion 170, described below. Therefore, the pressing portion 160 should continuously apply pressure to the folding portion 40 until the tape P is attached to the folding portion 40.

Considering this, multiple pressing portions 160 of the present embodiment may be disposed along the third direction (Y-axis direction). In this case, the third direction may be the longitudinal direction of the battery cell 10 or the longitudinal direction of the second terrace 25. For example, the third direction may be a direction orthogonal to the first and second directions.

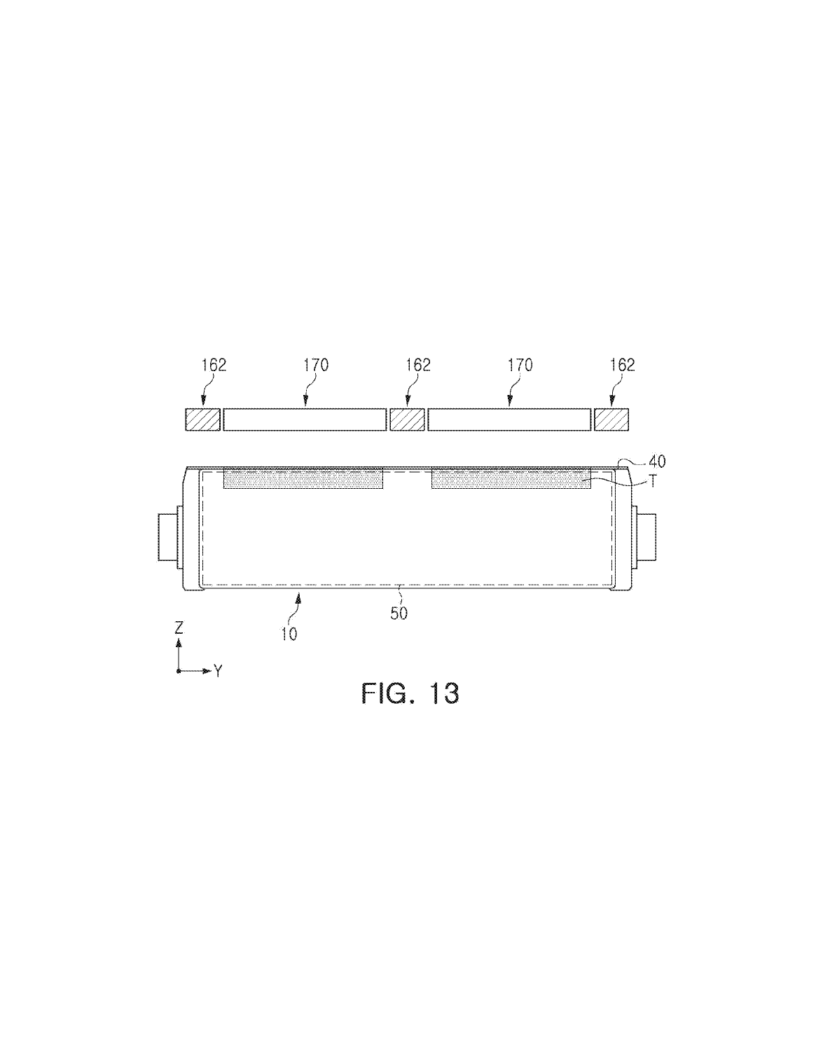

FIG. 13 is a side view schematically illustrating the disposing structure of the pressing portion and tape attachment device illustrated in FIG. 5.

As illustrated in FIG. 13, when the battery cell 10 is formed to be somewhat elongated, the pressing portion 160 of the present embodiment may press the folding portion 40 at both ends thereof along the third direction (Y-axis direction). Furthermore, the central portion of the folding portion 40 may be additionally disposed along the third direction (Y-axis direction) to press the folding portion 40. In this way, the number and position of the pressing portions 160 may be flexibly changed to correspond to the size and shape of the battery cell 10.

In an embodiment, a plurality of pressing portions 160 are disposed spaced apart from each other, and the tape attachment portion 170, described below, is positioned between the pressing portions 160 to attach the tape P. Therefore, the distance between the pressing portions 160 or the size/length of the pressing portion 160 may be determined by considering the size of the tape attachment portion 170 or the tape P attached to the folding portion 40.

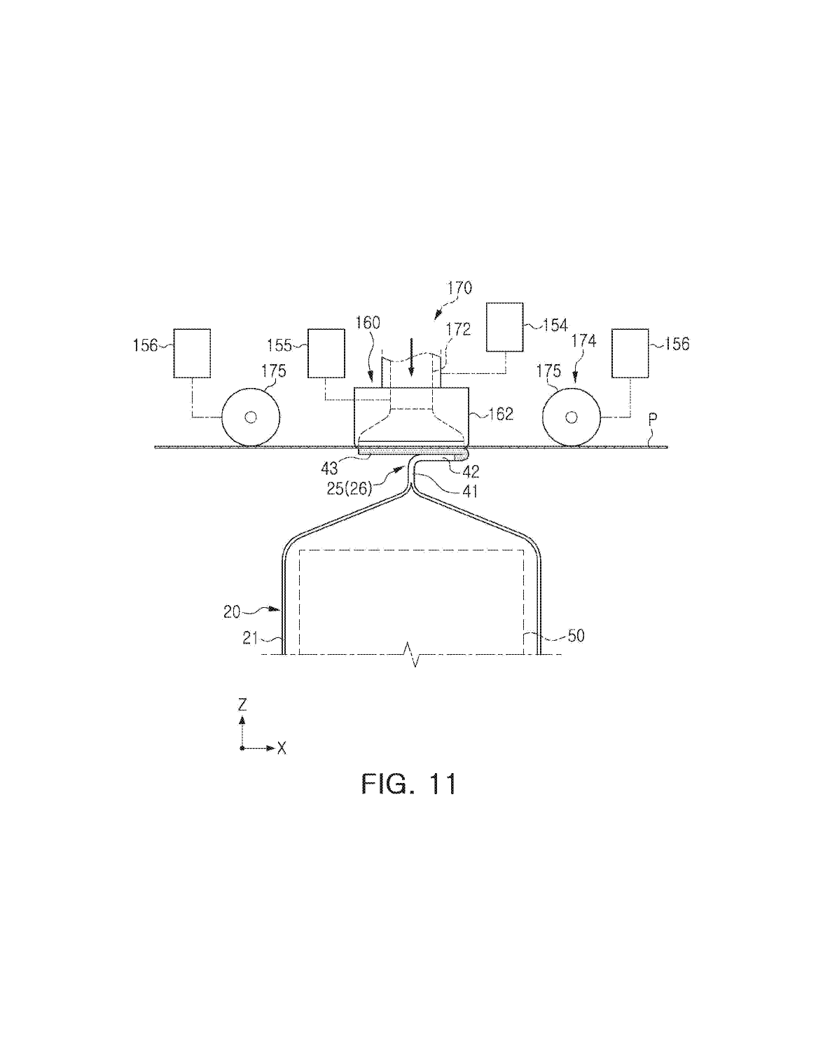

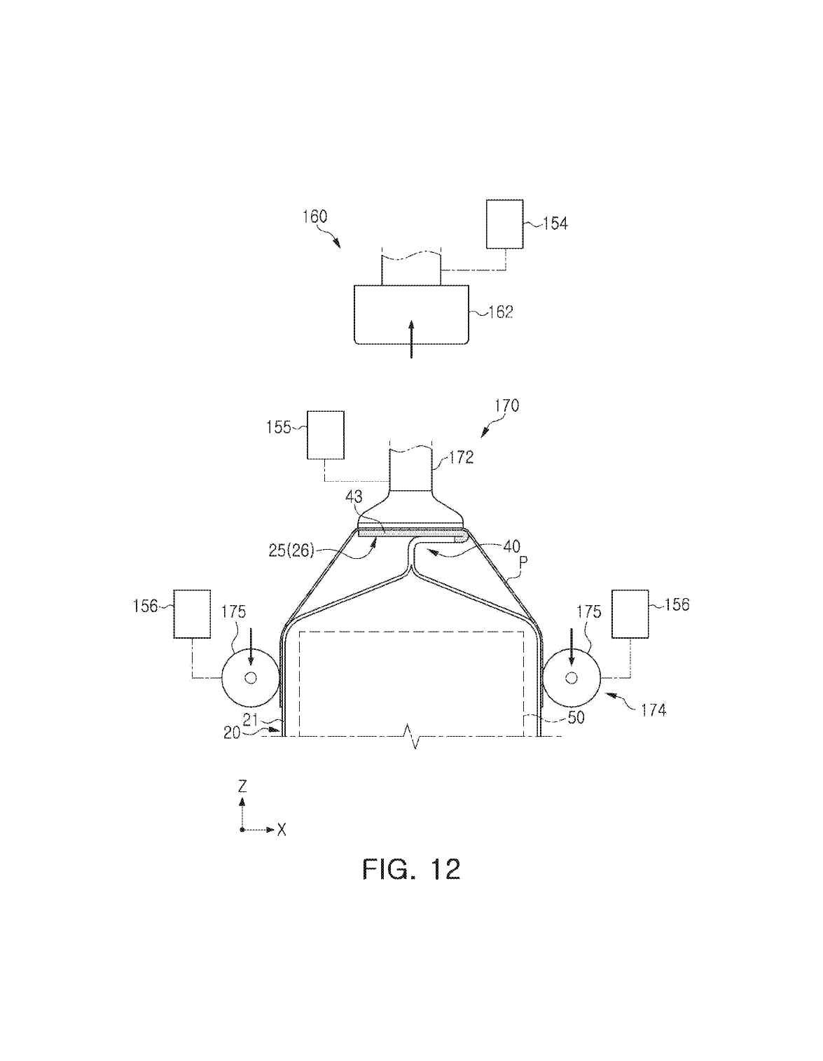

The tape attachment portion 170 may restrain the movement of the folding portion 40 by attaching a fixing member, such as tape P, to the folding portion 40 after the first bending member 120 and the second bending member 130 are repositioned. For example, as illustrated in FIGS. 11 and 12 , the tape attachment portion 170 may attach the central portion of the tape P to the third portion 43, pressurize the folding portion 40, and then attach both ends of the tape P to the electrode receiving portion 21, respectively.

The tape attachment portion 170 may be disposed at a predetermined distance from the battery cell 10 along the first direction and may be reciprocally moved in the first direction by the fourth driving unit 154, and may also be disposed between a plurality of pressing portions 160.

The tape attachment portion 170 may include an adsorption portion 172 that absorbs the tape P and attaches the central portion of the tape P to the terrace 25, and a pressing roller portion 174 that attaches both side portions of the tape P to the electrode receiving portion 21.

The adsorption portion 172 may absorb the back surface of the tape P and then transport the tape to attach the tape to the folding portion 40. In this case, the back surface of the tape P may refer to the opposite side of the adhesive surface of the tape P. The tape P may be supplied via a separate tape P supply device, and the adsorption portion 172 may utilize any known device capable of adsorbing and transporting the tape P.

The adsorption portion 172 may dispose the tape P so that the tape faces the third portion 43 of the folding portion 40, then move toward the folding portion 40 to attach the tape P to the third portion 43 of the folding portion 40. Therefore, the adsorption portion 172 may be disposed so that it faces the folding portion 40 and then reciprocally moved in the first direction. At this time, the adsorption portion 172 may position the tape P so that the center thereof corresponds to the first portion 41.

The pressing roller portion 174 may attach both side portions of the tape P to the electrode receiving portion 21. To this end, the pressing roller portion 174 may include a pair of rollers 175 disposed on the rear side of the tape P on both sides of the adsorption portion 172. The pair of rollers 175 may be arranged to be movable to a position facing the electrode receiving portion while pressing the tape P. For example, a plurality of rollers 175 may be disposed to reciprocate in the first direction.

A plurality of rollers 175 may be disposed on both sides of the adsorption portion 172, respectively. In detail, a plurality of rollers 175 may be disposed at a position spaced a certain distance from the adsorption portion 172 in the second direction, and may be disposed to face the rear surface of the tape P adsorbed to the adsorption portion 172.

Furthermore, a plurality of rollers 175 may further move toward the electrode receiving portion 21 than toward the adsorption portion 172. For example, the plurality of rollers 175 may move to a position facing the electrode receiving portion 21, and the respective rollers 175 may press a wide surface of the electrode receiving portion 21 during the movement. For example, the respective roller 175 may attach both side portions of the tape P to the wide surface of the electrode receiving portion 21 and press the tape P toward the electrode receiving portion 21.

The fifth driving unit 155 may move the adsorption portion 172. For example, the fifth driving unit 155 may move the adsorption portion 172 to a position where the tape P is loaded so that the adsorption portion 172 may adsorb the tape P. Furthermore, the adsorption portion 172 may be moved to a first position adjacent to the folding portion 40 so that the adsorption portion 172 may attach the tape P to the folding portion 40. In this case, the first position is a position where the adsorbed tape P faces the third portion 43 of the folding portion 40, and the center of the adsorbed tape P may correspond to the first portion 41.

Furthermore, the fifth driving unit 155 may move the adsorption portion 172 disposed at the first position toward the battery cell 10. During this process, the adsorption portion 172 may pressurize the third portion 43, thereby attaching the tape P adsorbed on the adsorption portion 172 to the third portion 43. Furthermore, once the attachment of the tape P is complete, the fifth driving unit 155 may return the adsorption portion 172 to the first position thereof.

The sixth driving unit 156 may reciprocate the pressing roller portion 174. For example, the sixth driving unit 156 may move a plurality of rollers 175 toward the electrode receiving portion 21 so that both side portions of the tape P may be attached to the electrode receiving portion 21. Thus, both side portions of the tape P may be pressed by the pressing roller portion 174 and attached to the surface of the electrode receiving portion 21. Furthermore, once the tape P attachment is complete, the sixth driving unit 156 may return the pressing roller portion 174 to the original position thereof.

As illustrated in FIG. 13, if the battery cell 10 is formed to be somewhat elongated, multiple tape attachment portions 170 may be provided. For example, a plurality of tape attachment portions 170 may be disposed spaced apart along the length of the battery cell 10, and the pressing portions 160 may be disposed between the tape attachment portions 170.

Next, a method for manufacturing a battery cell using the folding apparatus for a battery cell according to the present embodiment will be described.

First, as illustrated in FIG. 5, the battery cell 10 may be disposed between the first stripper 111 and the second stripper 115. At this stage, the battery cell 10 may not have a folding portion 40 formed, as illustrated in FIGS. 1 and 2.

Next, as illustrated in FIG. 6, the first stripper 111 and the second stripper 115 may be moved in the second direction (±X-axis direction) to pressurize the terrace 25. Thus, the terrace 25 may be fixed in motion by being caught between the first stripper 111 and the second stripper 115.

Next, as illustrated in FIG. 7, the first bending member 120 may be moved in the second direction (+X-axis direction) to pressurize the terrace 25. Accordingly, the terrace 25 may rotate in the second direction and fold, and the folded portion may be disposed between the first bending member 120 and the stripper 110.

Meanwhile, the folded portion may come into contact with the second bending member 130. For example, during the folding process of the terrace 25, the second surface of the terrace 25 may contact the second bending member 130, resulting in at least a portion of the terrace 25 being disposed on the outer side (or upper side) of the second bending member 130.

As the first bending member 120 performs the primary folding of the terrace 25, the folding portion 40 may form a boundary between the first portion 41 and the second portion 42.

Subsequently, as illustrated in FIG. 8, the second bending member 130 may move in the first direction (the -X-axis direction) and apply pressure to the terrace 25. The direction in which the second bending member 130 moves may be opposite to the direction in which the first bending member 120 moves. Accordingly, the terrace 25 may rotate and fold in the -X-axis direction.

As the second bending member 130 folds the terrace 25, the folding portion 40 may be divided into a second portion 42 and a third portion 43. As described above, the second portion 42 may include a region disposed between the first bending member 120 and the second stripper 115 of the terrace 25, and the third portion 43 may include a region disposed between the first bending member 120 and the second bending member 130 of the terrace 25. And the first portion 41 may include a portion disposed between the first stripper 111 and the second stripper 115 of the terrace 25.

As illustrated in FIGS. 9 and 10, after the first bending member 120 and the second bending member 130 are returned to the original positions thereof, the pressing portion 160 may press the third portion 43. Once the first bending member 120 and the second bending member 130 are returned to the original positions thereof, the second portion 42 and the third portion 43 may partially unfold bent portions thereof due to the springback phenomenon. Therefore, before the second portion 42 and the third portion 43 are fully unfolded, the pressing portion 160 may contact the third portion 43 and press the third portion 43 toward the second portion 42. Consequently, the second portion 42 and the third portion 43 may maintain the folded configuration thereof.

Meanwhile, while the present embodiment exemplifies a case in which the pressing portion 160 presses the third portion 43 after the first bending member 120 and the second bending member 130 are returned to the original positions thereof, the present disclosure is not limited thereto. For example, the pressing portion 160 may be disposed adjacently to the third portion 43 before the first bending member 120 and the second bending member 130 are returned to the original positions thereof. In this case, when the first bending member 120 and the second bending member 130 are returned to the original positions thereof, the folding portion 40 unfolds due to the springback phenomenon, allowing the third portion 43 to contact the pressing portion 160. Therefore, the process of the pressing portion 160 pressing the third portion 43 may be omitted or significantly reduced.

Next, as illustrated in FIG. 11, the suction portion of the tape attachment portion 170 may be positioned at a first position facing the folding portion 40 after absorbing the tape P. The suction portion may then move toward the folding portion 40 to attach the tape P to the third portion 43 of the folding portion 40. During this process, the pressing portion 160 may continuously press the folding portion 40.

Next, as illustrated in FIG. 12, the pressure roller 175 presses both side portions of the tape P and moves toward the electrode receiving portion 21, thereby attaching both side portions of the tape P to the electrode receiving portion 21.

Thereafter, the pressing portion 160 and the tape attachment portion 170 may be moved to the initial positions thereof, thereby completing the forming of the folding portion 40 of the battery cell 10.

When manufacturing a battery cell 10 using the folding apparatus for a battery cell 100 described above, the process of forming the folding portion 40 on the terrace 25 may be simplified, thereby improving productivity. Furthermore, the folding portion 40 may be easily formed and secured to the terrace 25.

Furthermore, the equipment required for folding processing may be simplified, reducing the costs associated with installing and maintaining the folding apparatus for a battery cell 100.

Hereinafter, embodiments will be further described with reference to specific experimental examples. The examples and comparative examples included in the experimental examples are intended to illustrate the present disclosure and do not limit the scope of the appended claims. It will be apparent to those skilled in the art that various modifications and variations of the examples are possible within the scope and spirit of the present disclosure, and it is understood that such modifications and variations fall within the scope of the appended claims.

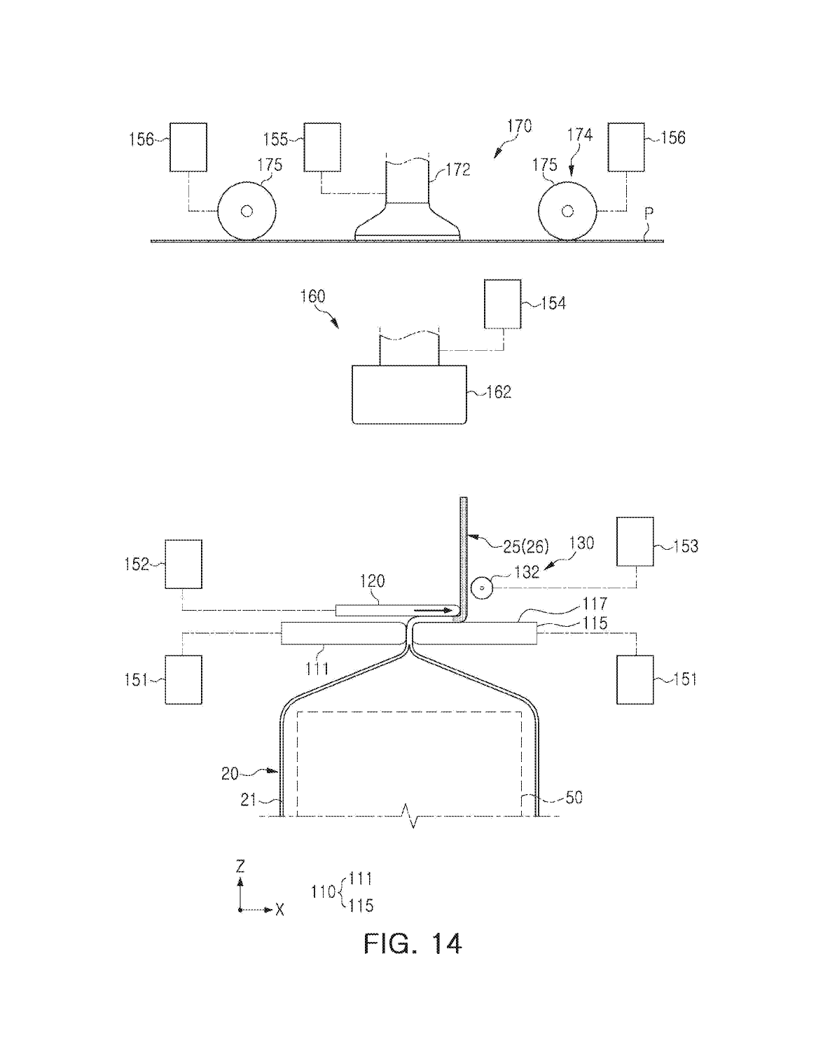

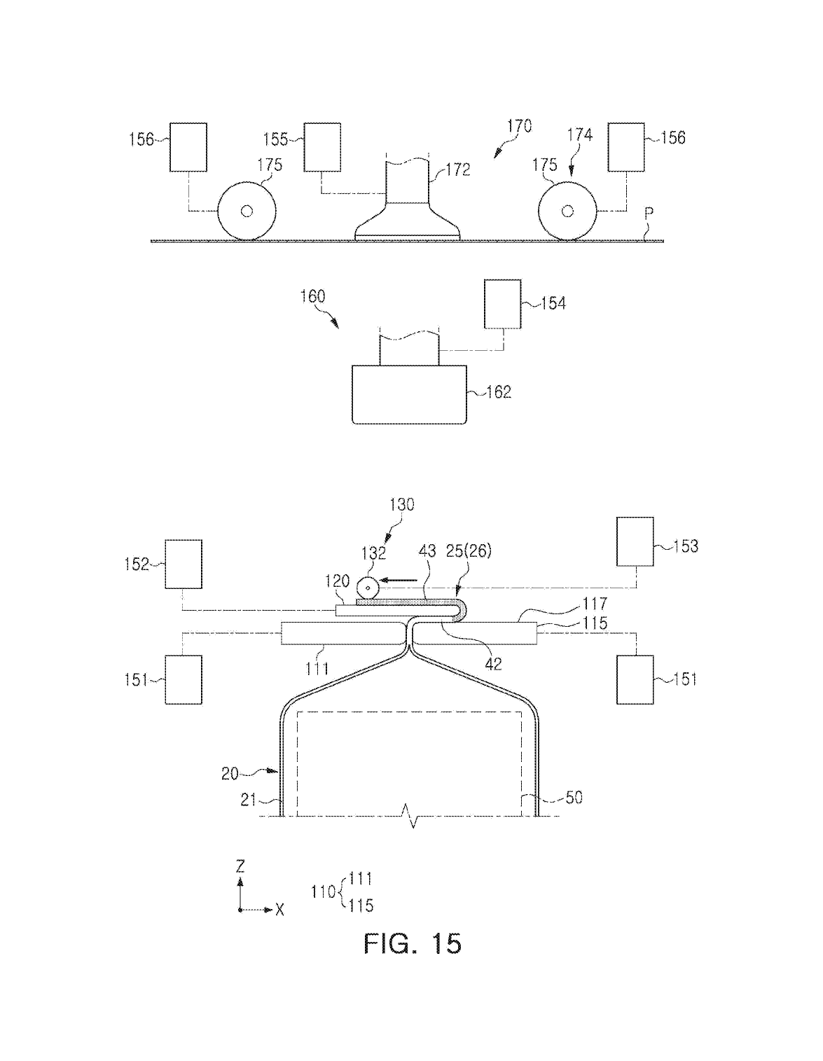

FIGS. 14 and 15 are schematic diagrams illustrating a folding apparatus for a battery cell according to another embodiment.

Referring to FIGS. 14 and 15, the folding apparatus for a battery cell of this embodiment is configured similarly to the previously described embodiment, except that the second bending member 130 may include a folding roller 132 instead of a blade.

The folding roller 132 of this embodiment may be formed in the form of a conventional roller and may roll and move in close contact with the outer surface of the first bending member 120. During this process, the third portion 43 of the terrace 25 may be pressed by the folding roller 132 and brought into close contact with the first bending member 120. A cushioning material may be disposed on the surface of the roller 175. The cushioning material may be formed of an elastically compressible material, such as rubber or foam, but is not limited thereto.

In this way, when using the folding roller 132, the folded portion of the terrace 25 may be elastically pressed, so that the folded portion may be folded more firmly, and thus, when the folding roller 132 is returned to the original position thereof, the unfolding of the third portion 43 due to the springback phenomenon may be significantly reduced.

As set forth above, according to an embodiment, the process of forming a folding portion on a terrace may be simplified and productivity may be improved.

According to an embodiment, the folding portion may be easily formed on a terrace.

According to an embodiment, the equipment for folding processing may be simplified and equipment costs may be reduced.

Only specific examples of implementations of certain embodiments are described. Variations, improvements and enhancements of the disclosed embodiments and other embodiments may be made based on the disclosure of this patent document.

What is claimed is:

1. A folding apparatus for a battery cell, comprising:
a stripper gripping a terrace of a cell case having an electrode receiving portion, the stripper being configured to restrain movement of the terrace;
a first bending member contacting a first surface of the terrace to press the terrace, and performing a first bending of the terrace;
a second bending member contacting a second surface of the terrace to press the terrace, and performing a second bending of the terrace; and
a tape attachment portion securing the terrace by attaching tape to the terrace while the terrace is folded.

2. The folding apparatus for a battery cell of claim 1, wherein the stripper includes a first stripper and a second stripper, disposed facing each other, with the terrace interposed therebetween,
wherein the first stripper and the second stripper move in a thickness direction of the electrode receiving portion, press the terrace, and suppress the movement of the terrace.

3. The folding apparatus for a battery cell of claim 2, wherein the first bending member and the second bending member move in the thickness direction of the electrode receiving portion to bend the terrace.

4. The folding apparatus for a battery cell of claim 3, wherein the first bending member and the second bending member move in opposite directions to bend the terrace.

5. The folding apparatus for a battery cell of claim 1, wherein a folding portion formed by bending the terrace includes a first portion restrained from movement by the stripper, a second portion extending from the first portion and disposed between the first bending member and the stripper, and a third portion extending from the second portion and disposed between the first bending member and the second bending member.

6. The folding apparatus for a battery cell of claim 5, wherein the second bending member bends the terrace such that the second portion and the third portion are disposed parallel to each other.

7. The folding apparatus for a battery cell of claim 5, further comprising a pressing portion pressing the terrace and maintaining a folded shape of the terrace, after the first and second bending members are returned to original positions thereof.

8. The folding apparatus for a battery cell of claim 7, wherein the pressing portion contacts the third portion and presses the third portion toward the electrode receiving portion.

9. The folding apparatus for a battery cell of claim 7, wherein the tape attachment portion includes,
an adsorption portion absorbing the tape and attaching a central portion of the tape to the terrace; and
a pressing roller portion attaching both side portions of the tape to the electrode receiving portion.

10. The folding apparatus for a battery cell of claim 9, wherein the pressing roller portion includes a pair of rollers disposed on a rear side of the tape, on both sides of the adsorption portion,
wherein the pair of rollers is arranged to be movable to a position facing the electrode receiving portion while pressing the tape.

11. The folding apparatus for a battery cell of claim 9, wherein the pressing portion is provided as a plurality of pressing portions spaced apart from each other, and
the tape attachment portion is positioned between the plurality of pressing portions to attach the tape.

12. The folding apparatus for a battery cell of claim 1, wherein the first bending member includes a blade, and the second bending member includes a blade or a folding roller.

13. A folding apparatus for a battery cell comprising:
a stripper gripping a terrace of a cell case having an electrode receiving portion, the stripper being configured to restrain movement of the terrace;
a bending member bending the terrace to form a folding portion;
a pressing portion pressing the folding portion to suppress springback of the folding portion; and
a tape attachment portion attaching tape to the folding portion pressed by the pressing portion to secure the folding portion.

14. The folding apparatus for a battery cell of claim 13, wherein the pressing portion is provided as a plurality of pressing portions spaced apart from each other, and
the tape attachment portion is disposed between the plurality of pressing portions.

15. The folding apparatus for a battery cell of claim 13, wherein the bending member bends the terrace while moving in a thickness direction of the electrode receiving portion.
